(19) United States
(12) Patent Application Publication
(10) Pub. No.: US 2019/0075856 A1
(43) Pub. Date: Mar. 14, 2019

(54) Guard for Use with Electronic Monitor Systems

(71) Applicants: Cynthia S. Roehm, Bowling Green, KY (US); Susan D. Sylvester, Oxford, MI (US)

(72) Inventors: Cynthia S. Roehm, Bowling Green, KY (US); Susan D. Sylvester, Oxford, MI (US)

(21) Appl. No.: 16/104,819

(22) Filed: Aug. 17, 2018

Related U.S. Application Data
(60) Provisional application No. 62/549,095, filed on Aug. 23, 2017.

(51) Int. Cl. A41D 1/00; G08B 21/22; A41D 27/22; G08B 21/02

(52) U.S. Cl. CPC A41D 1/002; G08B 21/22; A41D 27/22; G08B 29/04; A41D 2300/32; A41D 2300/33; G08B 21/0269

(57) ABSTRACT

A guard and method for securing a guard around an electronic monitoring device that is secured to a monitored individual's limb is provided. The guard includes a flexible fabric having an inner surface for receiving the electronic monitoring device, at least one fastener attached to a top portion of the inner surface and a bottom portion of an outer surface of the flexible fabric for releasably retaining the top portion to the bottom portion, and at least one ribbon loop. In one form, the flexible fabric includes a pair of peripheral edges disposed parallel to each other and each edge includes a cutout.

### FIELD

The present disclosure relates generally to electronic monitoring devices and more particularly to a guard for use with electronic monitoring devices.

### BACKGROUND

The statements in this section merely provide background information related to the present disclosure and may not constitute prior art.

Electronic monitoring devices are often used in law enforcement to monitor accused and convicted criminal Offenders, and even potential Victims. Electronic monitoring devices include, for example, Global Positioning System (GPS) tethers, radio-frequency (RF) tethers, and transdermal alcohol tethers.

Electronic monitoring devices include some form of tracking assembly that must be worn on a limb, typically an ankle, of the individual being monitored at all times. In order to secure the tracking assembly to the monitored individual, a tamper resistance, non-removable securing device, such as for example, a strap, is used that wraps around the individual's limb. The securing device must be strong enough to inhibit the monitored individual from removing the electronic monitoring device and therefore the material used may cause blistering, bruising, and bleeding of the individual's skin where the device is tightly secured.

### SUMMARY

The present disclosure provides for a guard for an electronic monitoring device that is secured to a monitored individual's limb, the electronic monitoring device having a tracking assembly and a securing device or strap to secure the tracking assembly to the monitored individual's limb, the guard having flexible fabric having an inner surface for receiving the electronic monitoring device, at least one fastener and at least one ribbon loop. The at least one fastener is attached to a top portion of the inner surface and a bottom portion of an outer surface of the flexible fabric for releasably retaining the top portion to the bottom portion.

The at least one ribbon loop may be disposed on the bottom portion or the top portion of the flexible fabric.

In one form, the flexible fabric and/or the ribbon loop is made of polyester material. In another form, the at least one fastener is selected from the group consisting of Velcro, a button, a zipper, and a hook.

The flexible fabric, in one form, further includes a pair of peripheral edges disposed parallel to each other. Each edge extends from the top portion to the bottom portion of the flexible fabric. In this form, each peripheral edge includes a cutout that abuts an edge of the tracking assembly such that an outer side of the tracking assembly is exposed and an inner side of the tracking assembly is in contact with the monitored individual's limb. The shape of the cutout may define a geometric shape selected from the group consisting of triangular, rectangular, square, and semicircle.

In another form, the flexible fabric has a predetermined length approximately equal to a length of the strap of the electronic monitoring device. In yet another form, the flexible fabric has a predetermined height configured to wrap around the strap of the electronic monitoring device such that the top portion and the bottom portion of the flexible fabric overlap and the at least one fastener releasably retains the top portion to the bottom portion.

In another form, an additional length (arm) of flexible fabric of a predetermined length and width of approximately equal to the amount of flexible fabric needed to cover the outer side of the tracking assembly of the electronic monitoring device, extends outside of one of the peripheral edges of the top portion of the outer surface and the bottom portion of the inner surface. The additional length of flexible fabric (arm) has an inner surface and an outer surface and a peripheral edge at the end of the additional length of flexible fabric. At least one fastener is located on the inner peripheral edge of the inner surface of the additional length of flexible fabric.

At least one fastener is attached to the peripheral edge of the top portion of the outer surface for releasably retaining the at least one fastener located on the inner peripheral edge of the inner surface of the additional length of flexible fabric. In this embodiment, the inner side of the tracking assembly is still in contact with the monitored individual's limb, and the additional length of flexible fabric covers the outer side of the tracking assembly. The at least one fasteners may be selected from a group consisting of Velcro, button, zipper and a hook.

The present disclosure further provides a method for wrapping a guard around an electronic monitoring device secured to a monitored individual's limb. The method comprises the steps of:

providing a guard comprising flexible fabric having an inner surface for receiving the electronic monitoring device, at least one fastener, and at least one ribbon loop;

placing the guard between the limb of the monitored individual and a strap of the electronic monitoring device such that the electronic monitoring device is centered with and in contact with the inner surface of the flexible fabric;

folding the bottom portion of the flexible fabric; and

folding the top portion of the flexible fabric such that the top portion overlaps the bottom portion and the at least one fastener attached to a top portion of the inner surface and a bottom portion of an outer surface releasably retains the top portion to the bottom portion.

In one form, the step of placing the guard between the limb and the strap comprises the steps of placing at least one finger through the at least one ribbon loop and adjusting the flexible fabric in place.

In another form, the flexible fabric includes a pair of peripheral edges disposed parallel to each other, where each peripheral edge includes a cutout. In this form, the step of placing the guard between the limb and the strap further comprises the step of abutting the cutouts of each peripheral edge to an edge of a tracking assembly of the electronic monitoring device such that an outer side of the tracking assembly is exposed and an inner side of the tracking assembly is in contact with the monitored individual's limb.

In another form, the flexible fabric includes an additional length (arm) of flexible fabric of a predetermined length and width of approximately equal to the amount of fabric needed to cover the outer side of the tracking assembly of the electronic monitoring device, extending outside of one of the peripheral edges of the top portion of the outer surface and the bottom portion of the inner surface, with at least one fastener attached to the peripheral edge of the inner surface of the additional length of flexible fabric and another at least one fastener located to the other peripheral edge of the top portion of the outer surface, for releasably retaining the at least one fastener located on the peripheral edge of the inner surface of the additional length of flexible fabric. In this form, an additional step of placing the additional length of flexible fabric over the outer side of the tracking assembly so that the at least one fastener attached to the peripheral edge of the inner surface of the additional length of flexible fabric is releasably retained by the at least one fastener attached to the peripheral edge of the top portion of the outer surface of the flexible fabric.

In still another form, at least one of the flexible fabric and the at least one ribbon loop is polyester. In yet another form, the at least one fastener is selected from the group consisting of Velcro, a button, a zipper, and a hook.

The flexible fabric may have a predetermined length approximately equal to a length of the strap of the electronic monitoring device. Even further, the flexible fabric may have a predetermined height configured to wrap around the strap of the electronic monitoring device such that the top portion and the bottom portion of the flexible fabric overlap and the at least one fastener releasably retains the top portion to the bottom portion

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an overview of a guard secured to a monitoring device in accordance with the principles of the present disclosure;

FIG. 2 is a front view of a guard constructed according to the present disclosure;

FIG. 3 is back view of a guard according to the present disclosure;

FIG. 4 is a side view of the guard according to FIG. 1;

FIG. 5 is a front view of one form of a guard according to the present disclosure;

FIG. 6 is a front view of one form of a guard according to the present disclosure;

FIG. 7 is a front view of one form of a guard according to the present disclosure;

FIGS. 8-11 illustrate installation of a guard around an electronic monitoring device according to the present disclosure;

FIG. 12 is a flow chart illustrating a method of wrapping a guard around an electronic monitoring device according to the present disclosure;

FIG. 13 is an overview of one form of a guard according to the present disclosure;

FIG. 14 is front view of one form of a guard according to the present disclosure;

FIG. 15 is a back view of one form of a guard according to the present disclosure; and

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

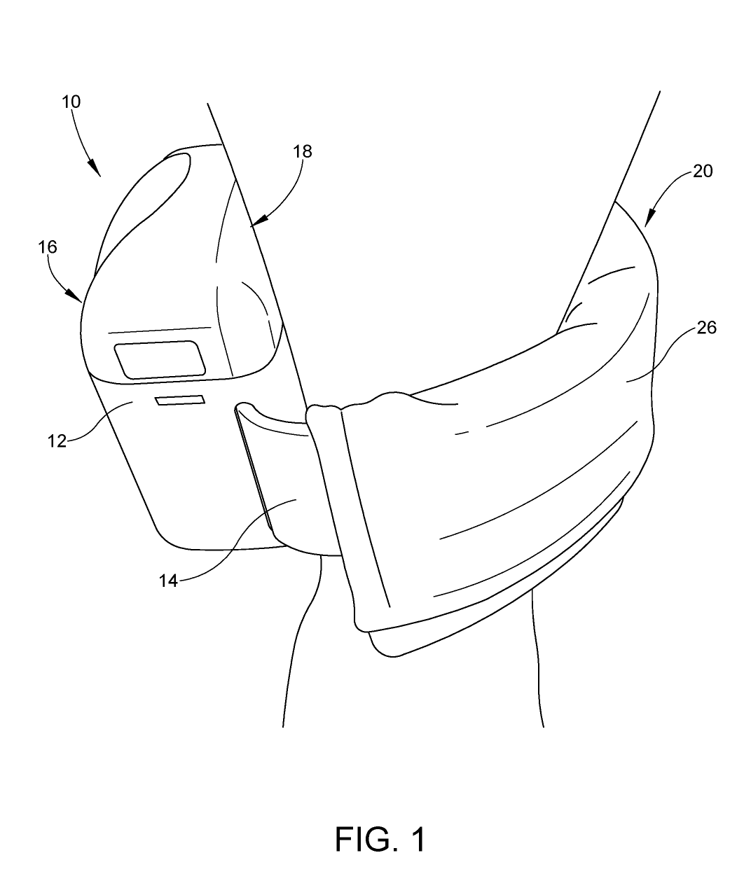

Referring to FIG. 1 a guard for an electronic monitoring device that is secured to a monitored individual's limb according to the principles of the present disclosure is illustrated and generally indicated by the reference number 20. The electronic monitoring device 10 typically includes a tracking assembly 12 and a securing device or strap 14 to secure the tracking assembly 12 to the monitored individual's limb.

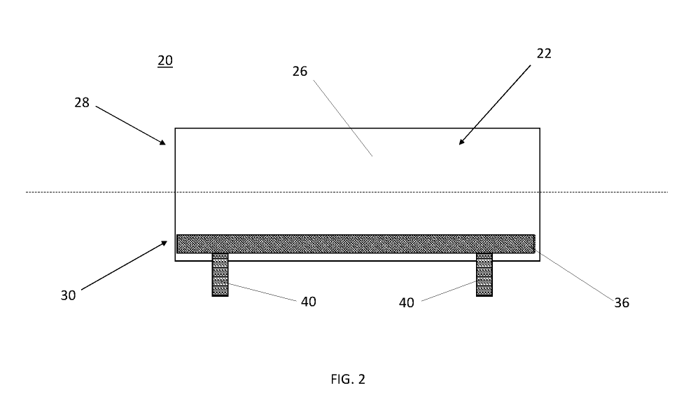

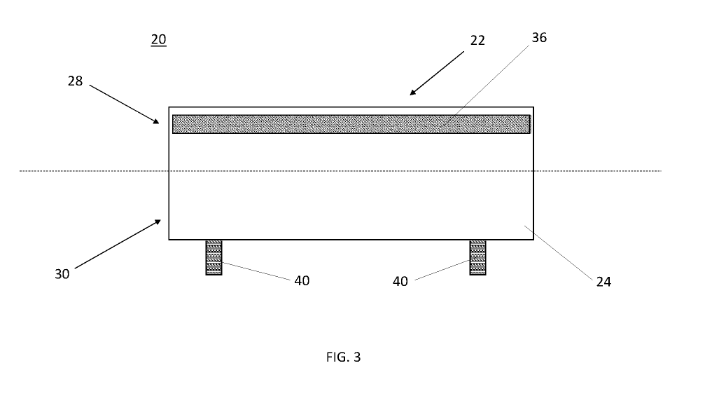

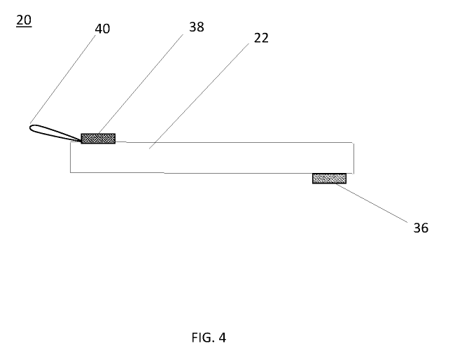

Referring to FIGS. 2 through 4, the guard 20 is illustrated and comprises at least one sheet of flexible fabric 22 having an inner surface 24 for receiving the electronic monitoring device 10, and at least one fastener 36 attached to a top portion 28 of the inner surface 24 (FIG. 3) and a bottom portion 30 of an outer surface 26 (FIG. 2) of the flexible fabric 22 for releasably retaining the top portion 28 to the bottom portion 30. The guard 20 further includes at least one ribbon loop 40 for easy installation in which the monitored individual can use to adjust the guard 20 into place.

Generally, the flexible fabric 22 defines a length approximately equal to a length of the strap 14 of the electronic monitoring device 10. In another example, the flexible fabric 22 defines a length equal to the combined length of the strap 14 and tracking assembly 12 such that the guard 20 covers the entire electronic monitoring device 10 when the guard 20 is in an installed position.

The flexible fabric 22 may further define a height configured to wrap around the strap 14 of the electronic monitoring device 10 such that the top portion 28 and the bottom portion 30 of the flexible fabric 22 overlap and the at least one fastener 36 releasably retains the top portion 28 to the bottom portion 30. In another example, the flexible fabric 22 defines a height configured to wrap around the strap 14 and the tracking assembly 14 such that the top portion 28 and the bottom portion 30 of the flexible fabric 22 overlap and the at least one fastener 36 releasably retains the top portion 28 to the bottom portion 30.

Therefore, the flexible fabric 22 is not limited to one configuration. For example, the flexible fabric 22 may define a length approximately equal to a length of the strap 14 and a height configured to wrap around the strap 14. In another example, the flexible fabric 22 defines a length equal to the combined length of the strap 14 and tracking assembly 12 and a height configured to wrap around the strap 14 and the tracking assembly 14.

The at least one ribbon loop 40, in one form, is disposed on the bottom portion 30 of the flexible fabric 22. Alternatively, the at least one ribbon loop 40 is disposed on the top portion 28 of the flexible fabric 22 (not shown). In another variation, the at least one ribbon loop 40 is disposed between two sheets of flexible fabric 22.

The components of the guard 20 may be any of a variety of materials and in one form, the flexible fabric 22 is polyester. In another form, the at least one ribbon loop 40 is polyester. In yet another form, the flexible fabric 22 and the ribbon loop 40 is polyester.

In other forms, the at least one fastener 36 is selected from the group consisting of Velcro, a button, a zipper, and a hook. However, any type of fastener that serves the purpose of releasably retaining the top portion 28 to the bottom portion 30 may be employed while still remaining within the scope of the present disclosure.

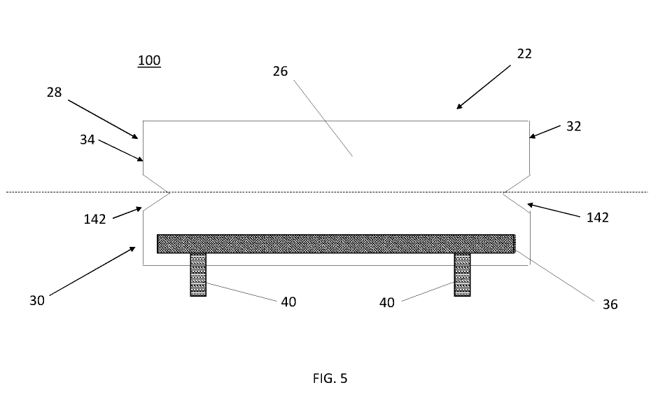

Referring now to FIG. 5, another variation of the guard 100 is illustrated according to the present disclosure. In this form, the flexible fabric 22 further includes a pair of peripheral edges 32, 34 disposed parallel to each other and each edge 32, 34 extending from the top portion 28 to the bottom portion 30. Each peripheral edge 32, 34 includes a cutout 142. Each cutout 142 abuts an edge of the tracking assembly such that an outer side 16 of the tracking assembly 12 is exposed and an inner side 18 of the tracking assembly 12 is in contact with the monitored individual's limb (FIG. 1).

Although the cutout 142 shown in FIG. 5 defines a triangular geometric shape, however, other geometric shapes, such as for example rectangular, square and semicircle, may be employed while still remaining within the scope of the present disclosure.

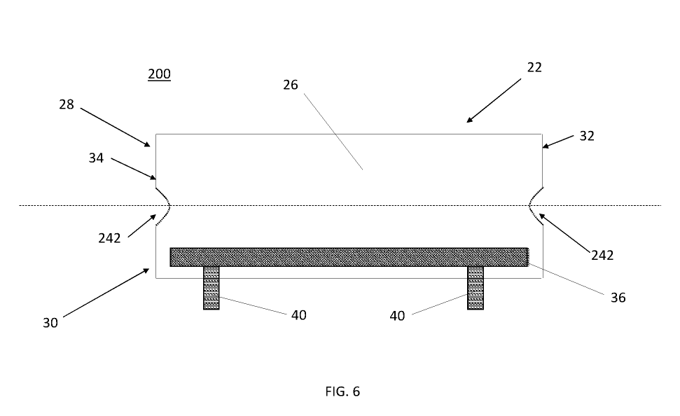

FIG. 6 illustrates a cutout 242 according to one example defining a semicircle geometric shape.

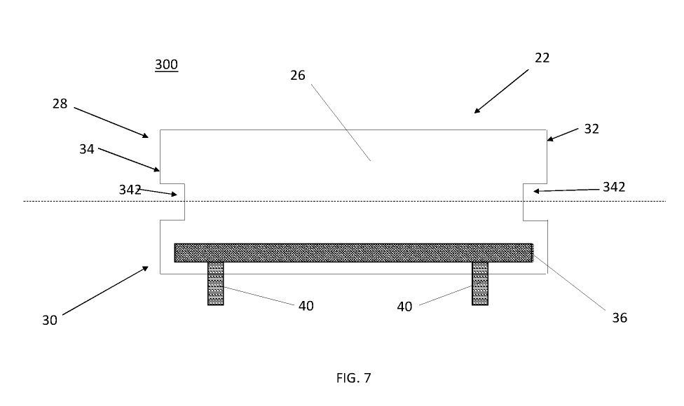

FIG. 7 illustrates a cutout 342 according to another example defining a rectangular geometric shape.

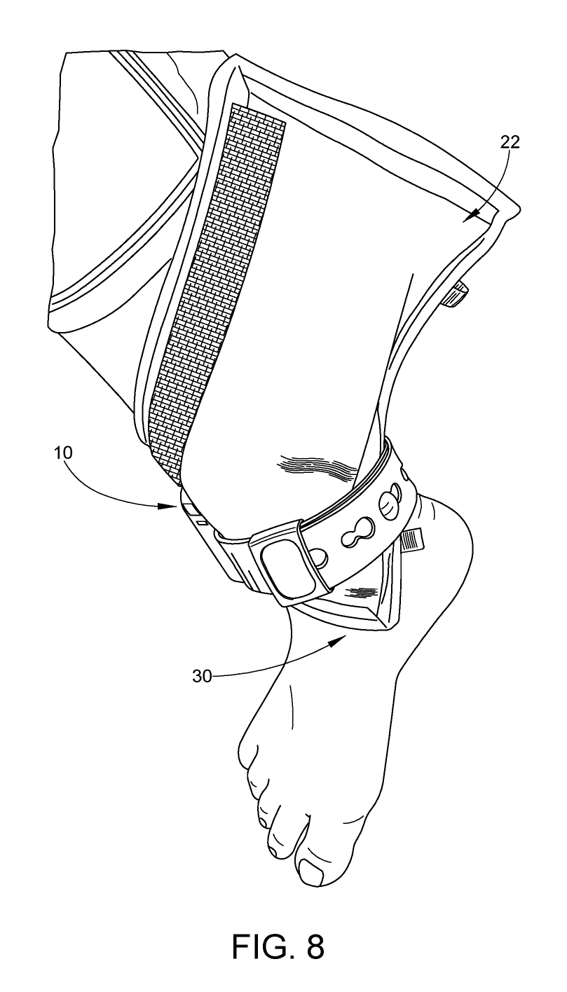

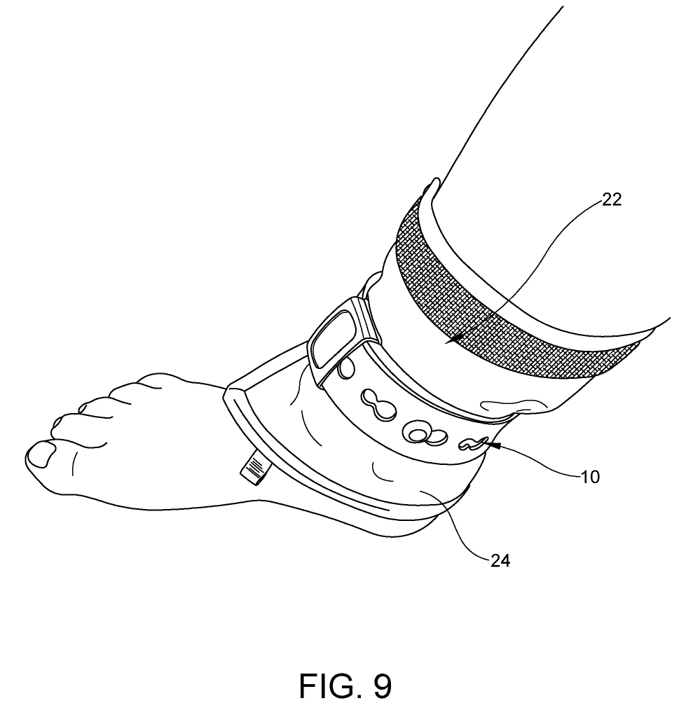

Referring to FIGS. 8 through 11 illustrate the installation of a guard 20 around an electronic monitoring device 10 that is secured to a monitored individual's limb. In FIG. 8, the bottom portion 30 of the flexible fabric 22 is placed between the electronic monitoring device 10 and the limb of the individual. The guard 20 is then manipulated and adjusted such that the electronic monitoring device 10 is centered with and in contact the inner surface 24 of the flexible fabric 22 (FIG. 9).

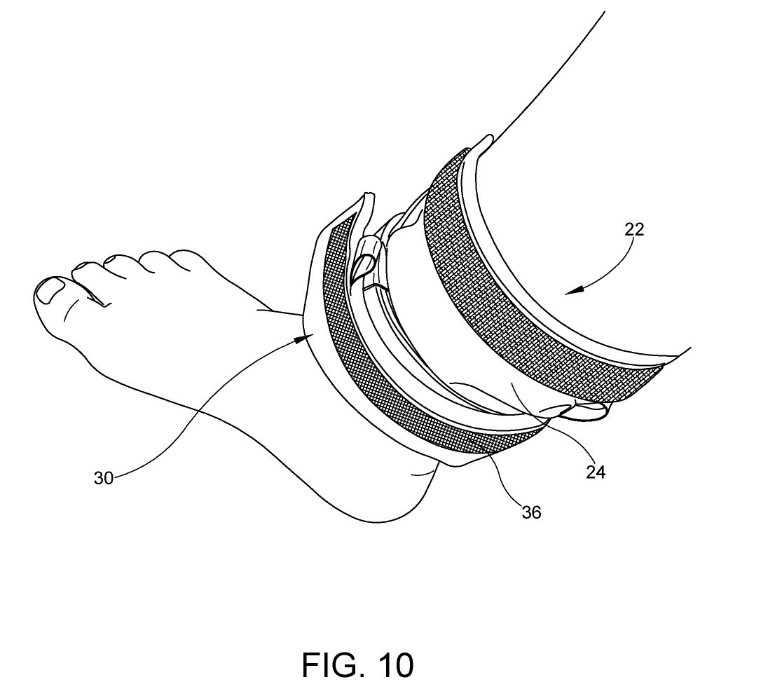

In FIG. 10, the bottom portion 30 of the flexible fabric 22 is folded upwards such that the inner surface 24 of the bottom portion 30 covers the strap 14 of the electronic monitoring device 10 and a fastener 36 attached to the bottom portion 30 of the outer surface 26 is exposed.

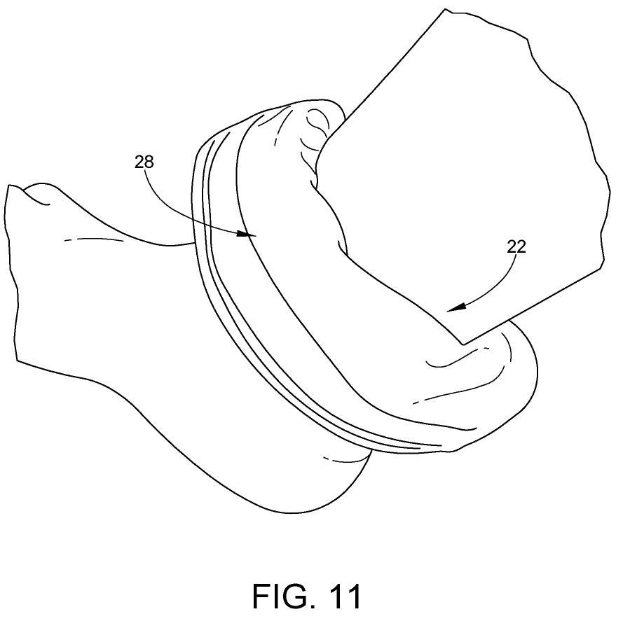

In FIG. 11, the top portion 28 of the flexible fabric 22 is folded downwards such that the top portion 28 overlaps the bottom portion 30 and the fastener 36 attached to the top portion 28 of the inner surface 24 engages with the exposed fastener 36 and releasably retains the top portion 28 to the bottom portion 30.

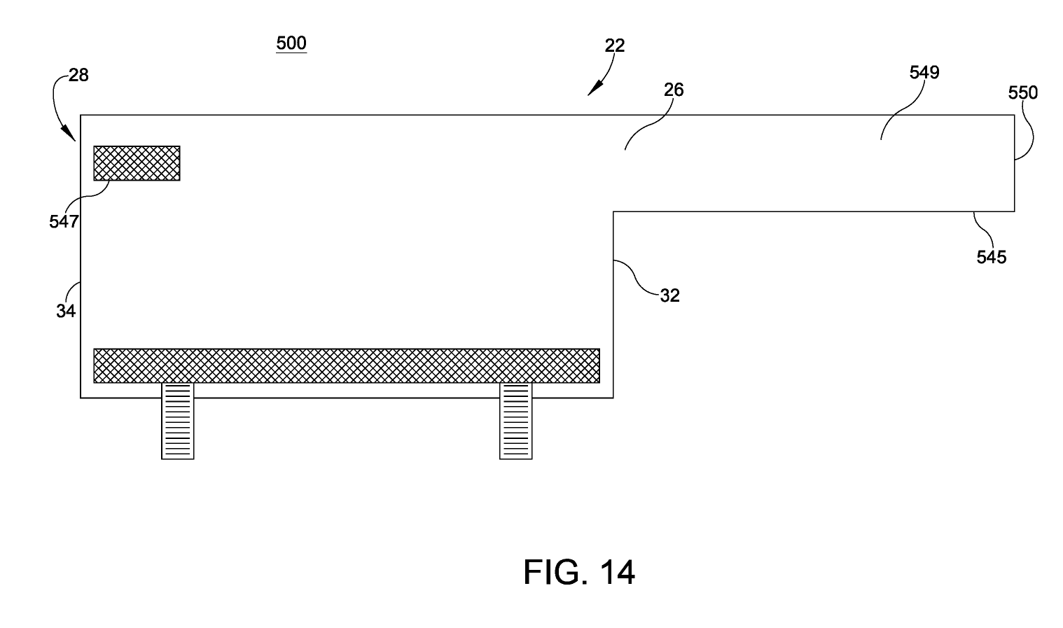

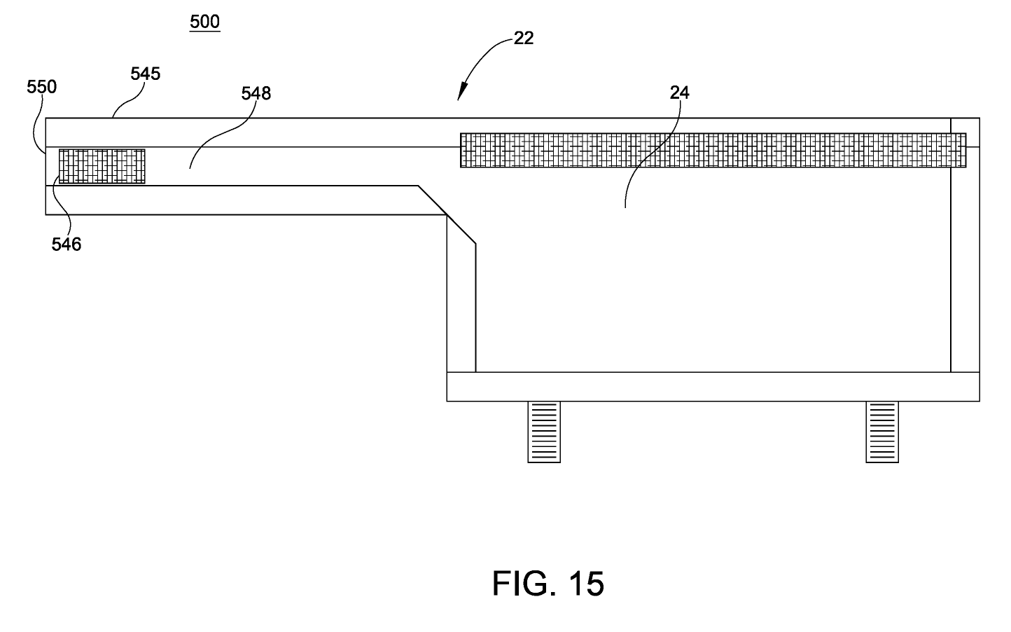

Referring now to FIGS. 14 and 15, another variation of the guard 500, is illustrated according to the present disclosure. In this form, an additional length of flexible fabric 545, of a predetermined length and width of approximately equal to the amount of flexible fabric needed to cover the outer side 16 of the tracking assembly 12 of the electronic monitoring device 10, extends outside of one of the peripheral edges 32, 34 of the top portion 28 of the outer surface 26 of the flexible fabric 22. The additional length of flexible fabric 545 has an inner surface 548 and an outer surface 549 and a peripheral edge 550 at the end of the additional length of flexible fabric 545. At least one fastener 546 is attached near the peripheral edge 550 of the inner surface 548 of the additional length of flexible fabric 545. The components of the additional length of flexible fabric 545, may be any of a variety of materials and in one form, the additional length of flexible fabric is polyester.

At least one fastener 547 is attached to the top portion 28 of the flexible fabric 22 on the outer surface 26 for releasably retaining the at least one fastener 546 attached near the peripheral edge 550 of the inner surface 548 of the additional length of flexible fabric 545. In this embodiment, the inner side 18 of the tracking assembly 12 is still in contact with the monitored individual's limb, and the additional length of flexible fabric 545 covers the outer side 16 of the tracking assembly 12. The at least one fasteners may be selected from a group consisting of Velcro, button, zipper and a hook. However, any type of fastener that serves the purpose of releasably retaining the additional length of flexible fabric 545, to the outer surface 26 of the flexible fabric 22, may be employed while still remaining within the scope of the present disclosure.

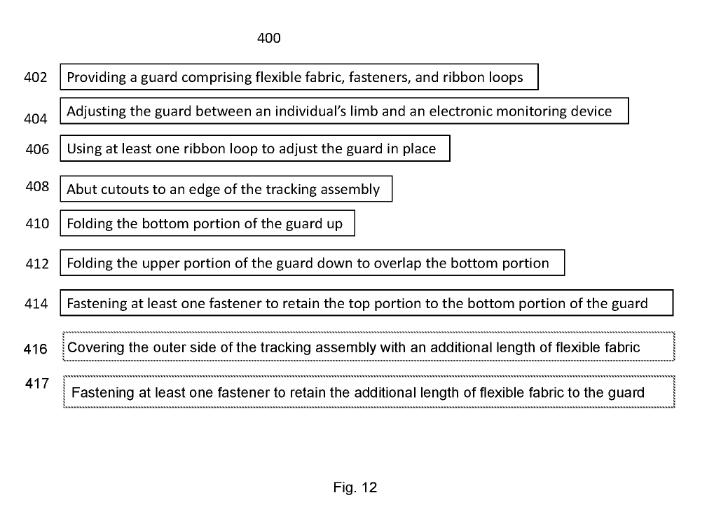

Referring to FIG. 12, the present disclosure further includes a method 400 for wrapping a guard around an electronic monitoring device secured to a monitored individual's limb, as described above. At 402, a guard is provided that comprises a flexible fabric having an inner surface for receiving an electronic monitoring device, at least one fastener, and at least one ribbon loop (FIGS. 2-4).

At 404, the guard is placed between the limb of the monitored individual and a strap of the electronic monitoring device such that the electronic monitoring device is centered with and in contact with the inner surface of the flexible fabric (FIG. 9)

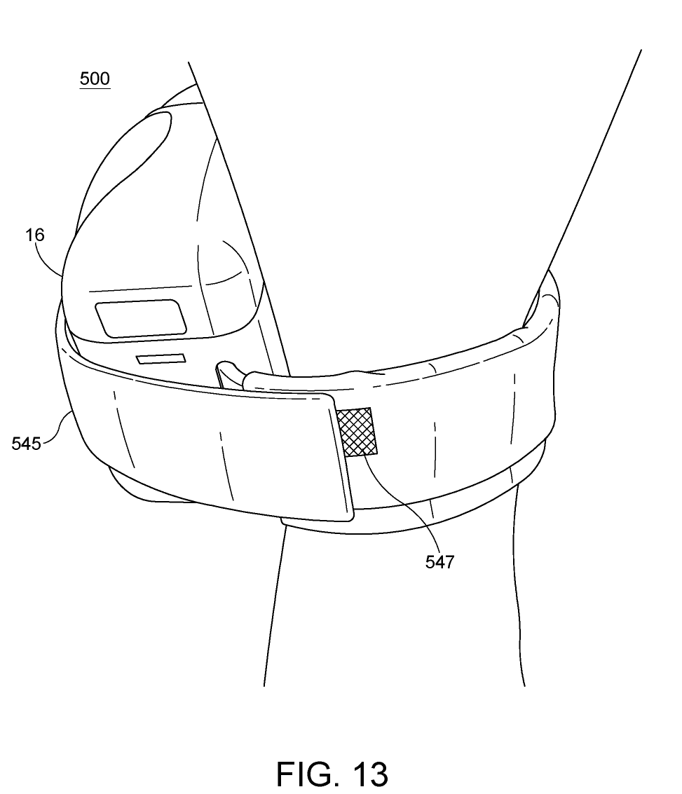

At 410, the bottom portion of the flexible fabric is folded up (FIG. 12). At 412, the top portion of the flexible fabric is folded down and overlaps the bottom portion (FIG. 11). At 414, the fasteners attached to the bottom and top portion of the guard engage together to releasably retain the top portion to the bottom portion (FIG. 13).

At 406, in one form, the step of placing the guard between the limb and the strap comprises the steps of using at least one ribbon loop to adjust the guard in place.

At 408, in another form, the method further includes abutting cutouts disposed on each peripheral edge of the flexible fabric to an edge of a tracking assembly of the electronic monitoring device, before folding the bottom portion of the guard up, such that an outer side of the tracking assembly is exposed and an inner side of the tracking assembly is in contact with the monitored individual's limb (FIG. 1).

At 416, in another form, the method further includes covering the outer surface of the tracking assembly with an additional length of flexible fabric extending outside of one of the peripheral edges of the top portion of the outer surface (FIG. 13).

At 417, in yet another form, the method further includes fastening the additional length of flexible fabric to the outer surface of the flexible fabric (FIG. 13).

When the guard 20 is properly installed, the flexible fabric creates a barrier between the hard electronic monitoring device and the monitored individual's limb thereby decreasing any blistering, bruising, and bleeding that may occur from the device being tightly secured to the limb.

Additional images of an exemplary guard are shown in Appendix A.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A guard for an electronic monitoring device that is secured to a monitored individual's limb, the electronic monitoring device having a tracking assembly and a securing device or strap to secure the tracking assembly to the monitored individual's limb, the guard comprising:
at least one sheet of flexible fabric having an inner surface for receiving the electronic monitoring device;
at least one fastener attached to a top portion of the inner surface and a bottom portion of an outer surface of the flexible fabric for releasably retaining the top portion to the bottom portion; and
at least one ribbon loop.

2. The guard according to claim 1, wherein the at least one ribbon loop is disposed on the bottom portion of the flexible fabric.

3. The guard according to claim 1, wherein the at least one ribbon loop is disposed on the top portion of the flexible fabric.

4. The guard according to claim 1, wherein the flexible fabric is polyester.

5. The guard according to claim 1, wherein the at least one ribbon loop is polyester.

6. The guard according to claim 1, wherein the at least one fastener is Velcro.

7. The guard according to claim 1, wherein the at least one fastener is selected from the group consisting of a button, a zipper, and a hook.

8. The guard according to claim 1, wherein the flexible fabric further includes a pair of peripheral edges disposed parallel to each other, each edge extending from the top portion to the bottom portion, each peripheral edge includes a cutout.

9. The guard according to claim 8, wherein each cutout abuts an edge of the tracking assembly such that an outer side of the tracking assembly is exposed and an inner side of the tracking assembly is in contact with the monitored individual's limb.

10. The guard according to claim 8, wherein the cutouts define a geometric shape selected from the group consisting of triangular, rectangular, square, and semicircle.

11. The guard according to claim 1, wherein the flexible fabric defines a length approximately equal to a length of the strap of the electronic monitoring device.

12. The guard according to claim 1, wherein the flexible fabric defines a height configured to wrap around the strap of the electronic monitoring device such that the top portion and the bottom portion of the flexible fabric overlap and the at least one fastener releasably retains the top portion to the bottom portion.

13. The guard according to claim 1, wherein the flexible fabric further comprises:
a pair of peripheral edges disposed parallel to each other, each edge extending from the top portion to the bottom portion;
an additional length of flexible fabric of extending from one of said peripheral edges, said additional length of flexible fabric comprising;
an inner surface;
an outer surface;
a peripheral edge;
at least one fastener attached to said inner surface of said additional length of fabric for releasably retaining said additional length to the outer surface of the flexible fabric and over the outer side of the tracking assembly.

14. A method for wrapping a guard around an electronic monitoring device secured to a monitored individual's limb, the method comprising:
providing a guard comprising at least one flexible fabric having an inner surface for receiving the electronic monitoring device, at least one fastener, and at least one ribbon loop;
placing the guard between the limb of the monitored individual and a strap of the electronic monitoring device such that the electronic monitoring device is centered with and in contact with the inner surface of the flexible fabric;
folding the bottom portion of the flexible fabric;
folding the top portion of the flexible fabric such that the top portion overlaps the bottom portion; and
fastening the at least one fastener attached to a top portion of the inner surface and a bottom portion of an outer surface releasably retains the top portion to the bottom portion.

15. The method according to claim 13, wherein placing the guard between the limb and the strap comprises the steps using the at least one ribbon loop to adjust the flexible fabric in place.

16. The method according to claim 13, wherein the flexible fabric includes a pair of peripheral edges disposed parallel to each other, each peripheral edge includes a cutout.

17. The method according to claim 15, wherein placing the guard between the limb and the strap further comprises the step of abutting the cutouts of each peripheral edge to an edge of a tracking assembly of the electronic monitoring device such that an outer side of the tracking assembly is exposed and an inner side of the tracking assembly is in contact with the monitored individual's limb.

18. The method according to claim 13, wherein at least one of the flexible fabric and the at least one ribbon loop is polyester.

19. The method according to claim 13, wherein the at least one fastener is selected from the group consisting of Velcro, a button, a zipper, and a hook.

20. The method according to claim 13, wherein the flexible fiber has a predetermined length approximately equal to a length of the strap of the electronic monitoring device.

21. The method according to claim 13, wherein the flexible fabric has a predetermined height configured to wrap around the strap of the electronic monitoring device such that the top portion and the bottom portion of the flexible fabric overlap and the at least one fastener releasably retains the top portion to the bottom portion.

22. The method according to claim 14, wherein the method further comprises:
covering the outer side of the tracking assembly with an additional length of flexible fabric; and
fastening at least on fastener to retain the additional length of fabric to the guard.
